(19) United States
(12) Patent Application Publication
(10) Pub. No.: US 2014/0337207 A1
(43) Pub. Date: Nov. 13, 2014

(54) METHOD, DEVICE, SERVER, AND SYSTEM FOR MAKING PAYMENT WITH A MESSAGING APPLICATION ON A MOBILE DEVICE

(71) Applicant: Tencent Technology (Shenzhen) Company Limited, Shenzhen City, Guangdon (CN)

(72) Inventors: Xiaolong Zhang, Shenzhen City (CN); Wa Ye, Shenzhen City (CN); Peng Liu, Shenzhen City (CN); Ming Chen, Shenzhen City (CN); Nan Jiang, Shenzhen City (CN)

(21) Appl. No.: 13/990,793

(22) PCT Filed: Apr. 28, 2013
(86) PCT No.: PCT/CN2013/075013

§ 371 Date: May 30, 2013

(51) Int. Cl. G06Q 20/32

(52) U.S. Cl. CPC G06Q 20/3255
USPC 705/41

(57) ABSTRACT

A first aspect of the present disclosure provides a device, server and system for making a payment from a messaging application on a mobile device. A second aspect of the disclosure provides a method of associating a payer account number with a mobile device. Further provided herein is a method of performing a payment transaction from a messaging application on a mobile device, wherein the payment transaction is initiated by a message or a 2D image from an OpenID with the messaging application, a 2D image from a website, or a mobile application from the merchant.

### TECHNICAL FIELD

The present disclosure relates generally to the technological field of mobile payment, and more particularly, to method, device, server, and system for making a payment with a messaging application on a mobile device.

### BACKGROUND

Mobile payments have been increasing rapidly as people become more and more relied on mobile devices in their daily life. However, the currently used mobile payment technologies are mostly based on merchant website to complete the payment transactions, using the mobile device only as a credit card, or the payment has to be completed through a third party intermediary account. The deficiencies of these mobile payment technologies are: there lacks communications between the merchant and the buyer, the buyer has to go through a series of operations to complete the transaction, limiting the buying experience, and there are concerns about privacy and security issues in mobile payment because the lack of communications between the merchant and the buyer. There is a need for more convenient payment transaction methods using a mobile device with increased user experience, privacy and security.

Another trend in mobile computing is the increasing popularity in messaging-based social network applications, such as microblogging and instant messaging. The latter trend has grown not only in personal social networks, but also leads to tremendous commercial opportunities for businesses because of its interactive nature. Messaging-based social network applications present as a good option for mobile payments by offering better buying experience and increased privacy and security.

### SUMMARY OF THE DISCLOSURE

One of the technical problems to be solved by the embodiments of the present disclosure is to provide a method, device, server, and system that enable efficient payment transaction on a mobile device.

To solve the above-identified technical problem, embodiments in a first aspect of the disclosure provide a mobile payment transaction server for making a payment from a messaging application on a mobile device. The mobile payment transaction server comprises: a transaction information module that retrieves and processes information associated with a payment transaction, a transaction identity module that generates and manages a unique transaction identity associated with the payment transaction, a messaging application module that communicates the information associated with the payment transaction and retrieves information associated with a payer account via a user interface of the messaging application, and a payment processing module that processes the payment transaction using the unique transaction identity and the information associated with the payer account.

Accordingly, embodiments in a second aspect of the disclosure provide a mobile device for making a payment transaction through a messaging application. The mobile device is associated with a payer account, the messaging application comprising a user interface that displays information associated with the payment transaction and a user interface that enables access to information associated with the payer account, the payment transaction being processed using the information associated with the payer account.

Accordingly, embodiments in a third aspect of the disclosure provide a system for making a payment transaction from a messaging application on a mobile device. The system comprises: a transaction information module that retrieves and processes information associated with a payment transaction, a transaction identity module that generates and manages a unique transaction identity associated with the payment transaction, a messaging application module that communicates the information associated with the payment transaction and retrieves information associated with a payer account via a user interface of the messaging application, a payment processing module that processes the payment transaction using the unique transaction identity and the information associated with the payer account, and a mobile communications module that transmits data to and/or retrieves data from the mobile device.

Accordingly, embodiments in a fourth aspect of the disclosure provide method of associating a payer account number with a mobile device. The method comprises: sending a user interface for entering a payer account number to the mobile device to be displayed by a messaging application, obtaining from the mobile device the payer account number, sending a user interface to the mobile device for entering a phone number assigned to the mobile device to be displayed by the messaging application, obtaining from the mobile device the phone number, sending a user interface for entering a payment password to be displayed by the messaging application, obtaining from the mobile device the payment password, and associating the payer account number with the phone number.

Accordingly, embodiments in a fifth aspect of the disclosure provide a method of performing a payment transaction from a messaging application on a mobile device. The method comprises: sending information associated with a product from a payee to the mobile device to be displayed by the messaging application, the payee having an account associated with the messaging application, sending a user interface to the mobile device to be displayed by the messaging application, comprising an offer from the payee, information associated with a payer account associated with the mobile device, and an input field for entering a payment password, and obtaining the entered payment password from the mobile device, completing the payment transaction on a server using the payer account when the payment password entered matches the payment password on record for the payer account associated to the mobile device, wherein the offer comprises information associated with the payment transaction.

Accordingly, embodiments in a sixth aspect of the disclosure provide a method of performing a payment transaction from a messaging application on a mobile device. The method comprises: receiving from the mobile device a scanned 2D image from a payee, the payee having an account with the messaging application, sending a user interface to the mobile device to be displayed by the messaging application, comprising an offer from the payee, information on a payer account associated with the mobile device, and an input field for entering a payment password, and obtaining the entered payment password from the mobile device, completing the payment transaction on a server using the payer account when the payment password entered matches the payment password on record for the payer account associated to the mobile device, wherein the offer comprises information associated with the payment transaction.

Accordingly, embodiments in a seventh aspect of the disclosure provide a method of performing a payment transaction from a messaging application on a mobile device. The method comprises: displaying a 2D image on a website, wherein the 2D image comprises information associated with the payment transaction, receiving from the mobile device the scanned 2D image, sending a user interface to the mobile device to be displayed by the messaging application, comprising an offer from a payee, information on a payer account associated with the mobile device, and an input field for entering a payment password, and obtaining the entered payment password from the mobile device, completing the payment transaction on a server using the payer account when the payment password entered matches the payment password on record for the payer account associated to the mobile device, wherein the offer comprises the information associated with the payment transaction.

Accordingly, embodiments in an eighth aspect of the disclosure provide a method of performing a payment transaction from a messaging application on a mobile device. The method comprises: receiving information associated with the payment transaction from another application from a payee, sending a user interface to the mobile device to be displayed by the messaging application, comprising an offer from the payee, information on a payer account associated with the mobile device, and an input field for entering a payment password, and obtaining the entered payment password from the mobile device, completing the payment transaction on a server using the payer account if the payment password entered matches the payment password on record for the payer account associated to the mobile device, wherein the offer comprises the information associated with the payment transaction.

Embodiments of the disclosure can provide at least the following useful effects, such as enabling the completion of a payment transaction from a mobile device, and enhancing user experience by allowing merchant-buyer interaction through a social network.

### BRIEF DESCRIPTION OF THE DRAWINGS

To clarify the technical features disclosed in the embodiments of the disclosure, a brief description of the figures in support of the disclosed embodiments is provided below. It should be understood that the figures only illustrate a number of embodiments of the disclosure. Additional figures can be derived from these figures by a person skilled in the art.

FIG. 1 is a schematic diagram illustrating exemplary components of a system for making a mobile payment with a messaging application on a mobile device, according to an embodiment of the disclosure.

FIG. 2 is a flow chart illustrating exemplary steps of a process for associating a payer account with a mobile device, according to an embodiment of the disclosure.

FIG. 3 is a flow chart illustrating exemplary steps of a process for performing a payment transaction via a messaging application, to a merchant associated with an OpenID, according to an embodiment of the disclosure.

FIG. 4 is a flow chart illustrating exemplary steps of a process for performing, using a messaging application on a mobile device, a payment transaction initiated from a payee's website, according to an embodiment of the disclosure.

FIG. 5 is a flow chart illustrating exemplary steps of a process for performing, using a messaging application on a mobile device, a payment transaction initiated by a link within another application, according to an embodiment of the disclosure.

FIG. 6 illustrates an exemplary user interface on a mobile device for entering, via a messaging application, a payer account number to be associated with the mobile device, according to an embodiment of the disclosure.

FIG. 7 illustrates an exemplary user interface on a mobile device for purchasing a product through an account associated with a messaging application, according to an embodiment of the disclosure.

FIG. 8 illustrates an exemplary user interface on a mobile device for entering, via a messaging application, a payment password for a payer account to make a payment, according to an embodiment of the disclosure.

FIG. 9 illustrates an exemplary user interface for a 2D image displayed on a website which encodes information on a payment transaction, according to an embodiment of the disclosure.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the broadest scope consistent with the claims.

In the following description of embodiments, reference is made to the accompanying drawings which form a part hereof, and in which it is shown by way of illustration specific embodiments of the disclosure that can be practiced. It is to be understood that other embodiments can be used and structural changes can be made without departing from the scope of the disclosed embodiments.

This disclosure describes techniques and methods that may enable a payment transaction being processed within a messaging application on a mobile device, the techniques and methods including, e.g., associating a payer account with a mobile device, completing a payment transaction using the associated payer account to a payee with an account with the messaging application, either initiated by a message by the payee within the messaging application or a 2D image by the payee outside the messaging application, completing a payment transaction using the associated payer account initiated by a 2D image displayed on, for example, a website, and completing a payment transaction initiated from another application on the mobile device.

### Process Overview

In one aspect, disclosed herein are a device, server and system for making a payment transaction using a messaging application on a mobile device. Although the present embodiments have been described with reference to specific exemplary embodiments, it will be evident that various modifications and changes may be made to these embodiments without departing from the broader spirit and scope of the various claims.

In this disclosure, the words “merchant”, “seller” and “payee” are used interchangeably to refer to any business, organization, group, entity, or individual that sells or offers to sell a product or service to a customer and receives a payment for the product sold or service rendered. The word “customer”, “buyer” and “payer” are used interchangeably to refer to any individual, business or organization that makes a payment for a product or service.

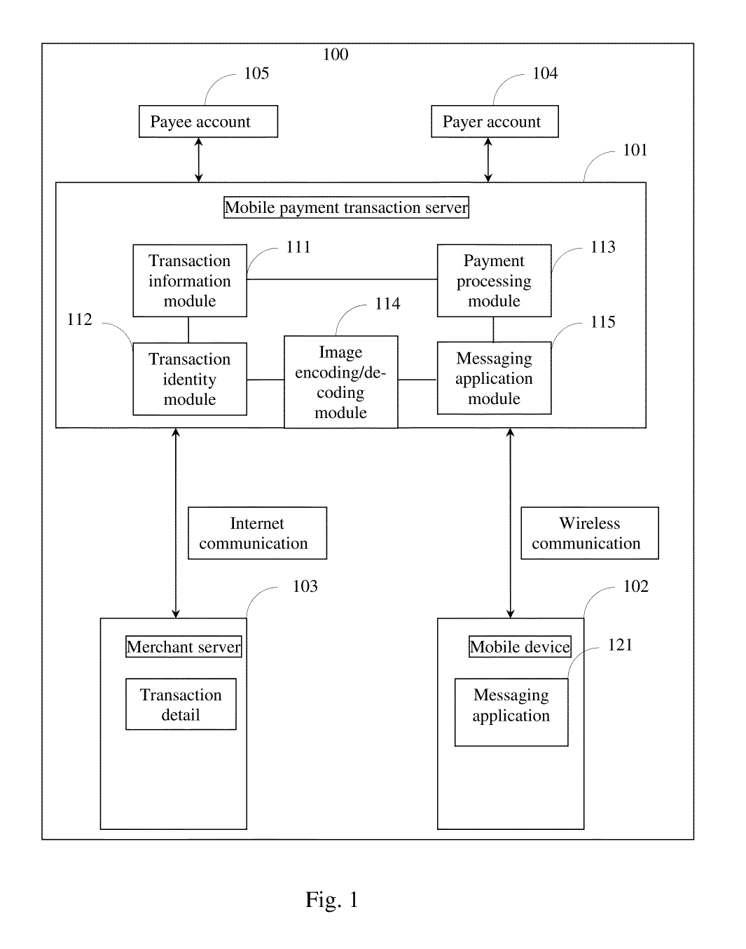

FIG. 1 is a schematic diagram illustrating an exemplary embodiment of a system for making a payment with a messaging application on a mobile device. The system 100 shows a mobile payment transaction server 101, a mobile device 102, a merchant server 103, a payer account 104 and a payee account 105. The mobile payment transaction server 101 may include one or more server computers located in single or multiple locations, which include processors and data storage systems commonly used for data processing and storage. Data processed and stored in the mobile payment transaction server 101 may include financial data, such as bank accounts, credit card accounts, brokerage accounts, or third party payment accounts; payment transaction data, such as a merchant ID, a customer ID, a product ID, a payment transaction ID; and personal data, such as name, age, sex, address, phone number, social security number, driver's license number, personal identification number, passport number, employment information, etc. The mobile payment transaction server 101 may include one or more modules including, but not limited to, a transaction information module 111, a transaction identity module 112, a payment processing module 113, an image encoding/decoding module 114, and/or a messaging application module 115.

Any suitable account with a financial institution may be used as the payer account or payee account in accordance with various embodiments in this disclosure. Examples of a payer account that can be used in accordance with various embodiments include, but are not limited to, a bank account, a credit card account, a brokerage account, or a third party payment account, and any account that may enable a financial transaction to a payee. Examples of a third party payment account that can be used in accordance with various embodiments include, but are not limited to, a PayPal account, a ZhiFuBao account, a ZhiFuTong account, and any other third party payment account which may enable a financial transaction to a payee from a linked bank account, credit card account, brokerage account, etc.

Any suitable payment transaction schemes may be used in accordance with various embodiments in the disclosure. For example, the mobile payment transaction server 101 may be authorized to directly access the payer account 104 in order to make a payment to the payee account 105. Alternatively, the mobile payment transaction server 101 may be authorized to access a third party payment account (e.g., PayPal, ZhiFuBao, CaiFuTong) in order to make a payment to the payee account 105, and the third party payment account is authorized to access the payer account 104. In this situation, the server computers on which the mobile payment transaction server 101 resides may be owned by the third party payment company, or co-owned by the third party payment company and the company of the messaging application.

In order to provide privacy protection for the buyers, the mobile payment transaction server 101 may limit its access to information about the products or services involved in payment transactions between a payer and a payee, and only have access to transaction information such as payment transaction ID, product ID, merchant ID, customer ID, etc. On the other hand, all the information about the product or service involved in the transaction may be saved on the merchant server 103. According to this arrangement, the detailed information of the product or service involved in a transaction may be inaccessible to the mobile payment transaction server 101, which means that the messaging application 121 does not have information about the buyer. As such, the buyer's privacy is protected.

Any suitable mobile device may be used in accordance with various embodiments of the disclosure. For example, the mobile device 102 may include a display terminal, an input unit, and a camera. The messaging application 121 on the mobile device 102 may use the display terminal for showing text, image, video, webpage, hyperlink, or a combination thereof. Examples of mobile devices that can be used in accordance with various embodiments include, but are not limited to, a tablet PC (including, but not limited to, Apple iPad and other touch-screen devices running Apple iOS, Microsoft Surface and other touch-screen devices running the Windows operating system, and tablet devices running the Android operating system), a mobile phone, a smartphone (including, but not limited to, an Apple iPhone, a Windows Phone and other smartphones running Windows Mobile or Pocket PC operating systems, and smartphones running the Android operating system, the Blackberry operating system, or the Symbian operating system), an e-reader (including, but not limited to, Amazon Kindle and Barnes & Noble Nook), a laptop computer (including, but not limited to, computers running Apple Mac operating system, Windows operating system, Android operating system and/or Google Chrome operating system), or an on-vehicle device running any of the above-mentioned operating systems or any other operating systems, all of which are well known to those skilled in the art.

Any suitable messaging application on a mobile device may be used according to various embodiments of the disclosure. For example, the messaging application may be a social network application, which allows its users to interact and establish relationships with each other by, for example, friending each other, following another user's public activities, joining the same community or group, and engaging in gaming activities with each other, etc. Both the merchant and the customer may have an account in the messaging application 121, and can communicate, interact and establish relationship through the messaging application 121. Examples of a messaging application that can be used in accordance with various embodiments of the disclosure may include, but are not limited to, a multimedia messaging or microblogging application which enables transfer of text, voice, image or video messages on a mobile device (including, but not limited to, Tencent WeChat, Tencent Weibo, Sina Weibo, Sohu Weibo, Netease Weibo, Twitter, Facebook), or an instant messaging application which enables transfer of text messages on a mobile device (including, but not limited to, Tencent QQ, Yahoo Messenger, MSN Messenger, BlackBerry Messenger, Skype).

In order for the merchant to sell or offer to sell a product or service through the messaging application, the account for the merchant may be a special category of account called an “OpenID” or a “Public Number”, which is described in more detail in another application entitled “[Method, device, and system for using a public number in a messaging application on a mobile device]”, the disclosure of which is incorporated herein in its entirety.

In particular, OpenID, as referred to herein, can refer to a personal, business, or group account associated with a social network application/platform for facilitating one or more services, operations, and/or communications/interactions to members of the social network. The application/platform supporting one or more OpenIDs can be referred to as Public Number application/platform, respectively. An example of OpenID platform is the WeChat OpenID platform by Tencent. An OpenID can be assigned to, represent, correspond to, or be associated with an individual user of a social network. In other embodiments, an OpenID can be assigned to, represent, correspond to, or be associated with an entity, such as an enterprise, organization (e.g., for-profit or non-profit), business (such as a corporation, company, partnership), business association, government or government agency, team, franchise, brand, campaign, foundation, group, and/or a political party, that is associated with a social network.

An OpenID can allow its owner to communicate with a community of users on the social network for various purposes. An OpenID can be used for facilitating information exchange and/or dissemination. Additionally or alternatively, an OpenID can provide entertainment or service to other members of the social network. For example, an OpenID may provide translation services, from one or more languages to another. A bank or other type of financial institution may utilize an OpenID to provide on-line and/or mobile banking services or other type of financial services, for example, on-line stock trading and investing. Additionally or alternatively, an OpenID can be used for offering an item for sale. In fact, any type of services or products can be provided through an OpenID.

In order for a merchant to be able to receive payment in the messaging application, it may set up a payee account 105 that can be associated with its OpenID. Preferably, the payee account 105 may be connected to the mobile payment transaction server 101, and receive payment from its payment processing module 113.

Associating of Payer Account with a Mobile Device

In another aspect, disclosed herein are methods for making a payment transaction through a messaging application on a mobile device, using the device, server and system for mobile payment transaction. Before a mobile device can be used for making a payment within a messaging application, a payer account, be it a bank account, a credit care, a third party payment account, may be associated with any information identifying the mobile device, such as a phone number associated with the mobile device, a serial number associated with the mobile device, a device identification number associated with the mobile device, etc. The information about the payer account associated with the mobile device may be saved to the mobile payment transaction server 101, for example, in the payment processing module 113.

Therefore, provided herein is a method for associating a payer account with a mobile device so that the payer account may be used for mobile payment transactions through the messaging application running on the mobile device. Associating of the payer account with the mobile device may be initiated by the messaging application when the buyer attempts to pay for a product without an existing payer account. Alternatively, the buyer may call a function in the messaging application to start the process of associating the payer account with the mobile device.

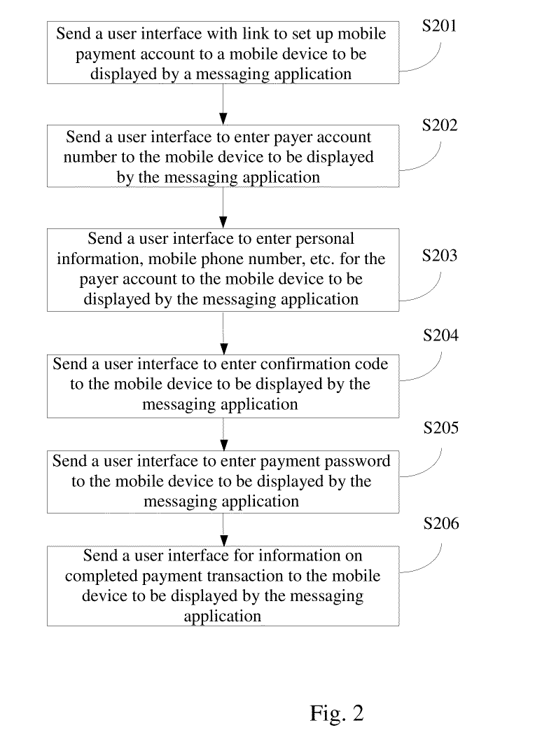

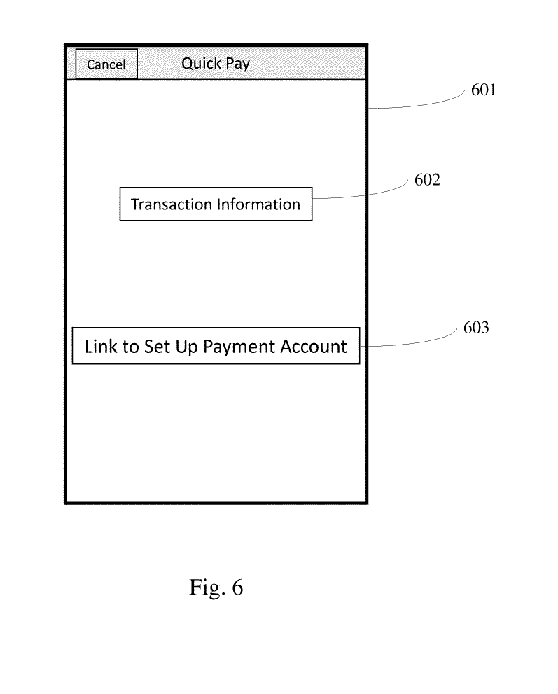

FIG. 2 is a flow chart illustrating an exemplary embodiment of a process to associate a payer account with a mobile device. Step 201: A server, such as the mobile payment transaction server 101 of FIG. 1, can send a payment transaction user interface to the mobile device to set up a payer account to be associated with the mobile device. An exemplary payment transaction user interface is provided in FIG. 6. As illustrated, the interface 601 can include payment transaction information 602 and a link 603 for setting up a payment account. The payment transaction user interface may be generated by the transaction information module 111 of the mobile payment transaction server 101, and processed by the messaging application module 115 to be displayed on the mobile device 102 (FIG. 1).

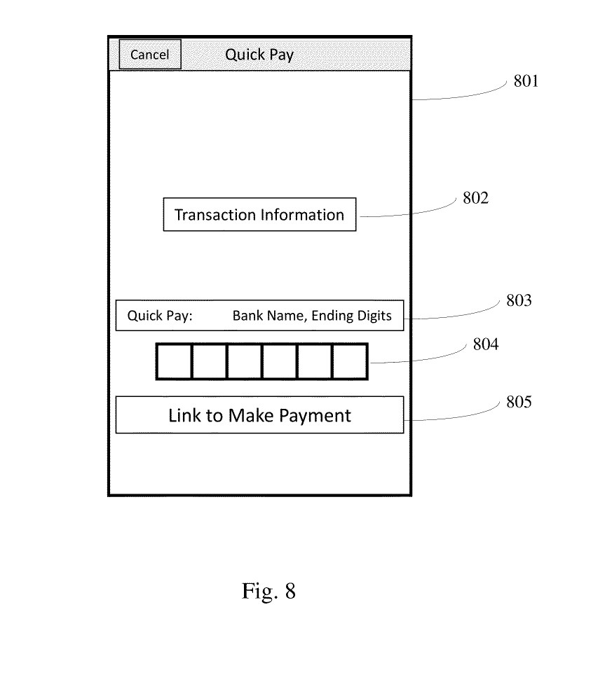

This user interface may be available when the messaging application module 115 receives an instruction to send a user interface for a payment transaction, and there has been no existing payer account associated with the mobile device. The information on the associated payer account may be available in the payment process module 113 or the transaction information module 111, and forwarded to the messaging application module 115. If there is no existing payer account associated with mobile device, this payment transaction user interface may either provide a link to associate a new payer account with the mobile device (e.g., interface of FIG. 6). Alternatively, if there is an existing payer account associated with the mobile device, the payment transaction user interface can show an input field to enter the payment password for the payer account (e.g., interface of FIG. 8). As used herein, a transaction payment user interface may include information about a product to be purchased by the buyer, including price, information of the product such as a brief description, color selection, size of the product, quantity of the product to be purchased, and the total value of the transaction.

This user interface to associate a payer account with the mobile device may be called up by the user of the messaging application through an interface item at any time. This user interface may also be available when there is already an existing account associated with the mobile device. As used herein, “interface item” can refer an item displayed on the screen of the mobile device within the messaging application, such as a button, a text field, a hyperlink, an input filed, etc.

Step 202: A server, such as the mobile payment transaction server 101, can send a user interface for entering an account number to be associated with the mobile device to the mobile device to be displayed in the messaging application. After receiving a positive feedback from the payment transaction user interface to associate a payer account number with the mobile device 102, the messaging application module 115 may send this user interface to the mobile device 102 to be displayed in the messaging application 121. The account number entered may be retrieved by the messaging application module 115, and forwarded to the payment processing module 113. The account number may be used for a payment transaction if this user interface is called upon from a payment transaction user interface 601. This user interface may also include a touch-based input device, such as a virtual keyboard, to enter the account number. Further, the user interface may include an interface item to leave the current user interface for, for example, the transaction information user interface. Additionally or alternatively, the user interface can include an interface item to go to the next user interface, for example, a user interface for entering information about the account number entered.

Step 203: A server, such as the mobile payment transaction server 101 can obtain the account number and send a user interface to enter information associated with the payer account to the mobile device to be displayed by the messaging application. Once the account number has been received by the messaging application module 115 of the mobile payment transaction server 101, the account number may be forwarded to the payment processing module 113, which in turn may identify the type of the account associated with the account number, and display the type of the account, and the financial institution with which the account is associated. For example, the account number may be associated with a bank, a credit card company, or a third party payment company. This user interface may include input fields for the buyer to enter, for example, a name, personal identification number associated with the account, and identification information for the mobile device 102, such as the phone number associated with the mobile device 102. The user interface may include a link to an agreement for the mobile payment, which may be accessed by the payer and a check box for indicating whether the payer has reviewed and agreed to the terms and conditions of the agreement. Further, the user interface may include an interface item to go back to the previous user interface, for example, the user interface for entering account number, and/or an interface item to go to the next user interface, for example, a user interface for mobile number confirmation.

Step 204: A server, such as the mobile payment transaction server 101 can send a user interface for entering a confirmation code to the mobile device to be displayed by the messaging application. After receiving the information on the payer account 104 and the phone number associated with the mobile device 102 from the messaging application module 115, or when receiving information from the transaction information module 111 on a transaction involving a total value above a predetermined threshold, the payment processing module 113 may generate a confirmation code and a confirmation user interface, which may be processed by the messaging application module 115 to be displayed on the mobile device 102. This user interface may be shown when a payer account 104 is being associated with a mobile device 102, or when a transaction involves a total value above a predetermined threshold, in order to verify that the mobile device 102 making the payment is the one associated with the payer account 104. The user interface may include an input field to enter the confirmation code. The user interface may also include a touch-based input device, such as a virtual keyboard, for entering the confirmation code. The user interface may include a short text reminding the payer about the mobile number to which the confirmation code was sent, with one or more of the digits optionally blanked out. The user interface may include an interface item for the payer to receive the confirmation code. Activating the user interface item for receiving the confirmation code may lead the mobile payment transaction server 101 to send a text message with the confirmation code to the phone number entered on the previous user interface, or the phone number associated with the payer account 104. Other confirmation information, such as personal identification properties (e.g., iris scan, DNA, fingerprint, typing rhythm, gait, and voice) may also be used to confirm the payer account. Further, the user interface may include an interface item to go back to the previous user interface, for example, the user interface for entering information about the account number, and/or an interface item to go to the next user interface, for example, a user interface for mobile number confirmation.

Step 205: A server, such as the mobile payment transaction server 101, can send a user interface for entering a payment password for the payer account associated with the mobile device to the mobile device to be displayed by the messaging application. After receiving the confirmation code from the confirmation user interface, the messaging application module 115 may forward the confirmation code to the payment processing module 113, which may match the received confirmation code with the one that has already been generated. Then, the payment processing module 113 may generate a payment password user interface to be processed by the messaging application module 115 and displayed on the mobile device 102. In subsequent payment transactions, this payment password may serve as the only item to be entered to complete a payment transaction using the associated payer account, to increase the efficiency of transactions and enhance user experience. The user interface to enter a payment password may come up only if the confirmation code received from the previous user interface in Step 204 matches the confirmation code sent to the phone number associated with mobile device 102. The user interface may include an input field for entering the payment password. The user interface may also include a touch-based input device, such as a virtual keyboard, to enter the payment password. The payment password may be a number with any number of digits, or a text with any number of letters, or a combination of number, letter (case sensitive or case non-sensitive), special character, etc. Some or all of the entered digits/letters/special characters of the password may be blocked to improve security. Further, the user interface may include an interface item to cancel the current user interface and go back to a previous user interface, for example, the user interface for entering an account number, and/or an interface item to complete the account associating process and go to the next user interface, for example, a user interface of completed payment transaction.

After the payment password has been received by the messaging application module 115, a user interface of information on a completed payment transaction may be generated and sent to the mobile device to be displayed by the messaging application, as described below in Step 206, if the payer account associating process is initiated from a payment transaction user interface. If the account associating process is initiated not from a payment transaction user interface, receiving the payment password may lead to the user interface before the account associating process was initiated.

After receiving the payment password entered in the user interface for entering payment password, the mobile payment transaction server 101 may complete a series of operations, including but not limited to, generating a payer account data having information on the phone number associated with mobile device 102, the payer account number associated with the mobile device 102, the payment password for the payer account 104, information linked to the payer account 104, etc. The payer account data may be saved on the payment processing module 113, for example.

Step 206: A server, such as the mobile payment transaction server 101, can send a user interface of information on a completed payment transaction to the mobile device to be displayed by the messaging application. After the completion of the association of the payer account 104 with the mobile device 102, the payment processing module 113 may proceed to use the payer account 104 to make a payment to a payee account 105, and notify the transaction information module 111 about the status of the payment transaction (FIG. 1). The transaction information module 111 may generate a user interface containing the information on the completed payment transaction, which may be processed and displayed by the messaging application module 115 on mobile device 102. The user interface may include information on the completed payment transaction including, but not limited to, the name of the payee, name of the product, transaction number, transaction completion time, name of the financial institution of the payer account, status of the transaction, a customer service number, value of the transaction, etc. Further, the user interface may include an interface item to complete the account associating process and return to the user interface before the transaction was initiated.

### Payment to an OpenID

Social network applications may provide enhanced buying experience and better customer service, such as shipping status tracking, customer feedback, personalized recommendations, etc. For example, a merchant may send a purchase confirmation, such as an electronic ticket to the buyer through the messaging application, a merchant may send a message about a new product or a discounted price to a user based on the past purchasing history of the user, or a merchant may update the shipping status of a product by sending a message to the buyer. Social network applications may also enhance a customer's buying experience by giving the customer the option to block out harassment from unwanted businesses by dissociating from such parties. For example, a customer may unfriend or remove from interest list a merchant if he/she is no longer interested in receiving information from the merchant.

Therefore, further provided herein is a method for making a payment transaction using a messaging application on a mobile device where the payee has an account, for example, an OpenID, in the messaging application. Social networks or applications may be used for various embodiments of the disclosure, wherein an OpenID may be associated with a buyer when the buyer becomes a friend or a fan of the OpenID, or if the buyer is interested in or follows the OpenID. Any OpenID may be paid through the mobile payment transaction system disclosed in the embodiments of the disclosure for the products or services provided through the OpenID. For Example, the OpenID may belong to any business, public figure, nonprofit organization, etc., and the products or services provided by the OpenID may include, but not limited to, books, electronics, games, subscription based publications, multimedia, entertainment, etc. When the OpenID belongs to a nonprofit organization, the mobile payment may be a donation, for example, to a charity. For a more detailed disclosure on OpenIDs, please refer to another application entitled “[Method, device, and system for using a public number in a messaging application on a mobile device]”, the disclosure of which is incorporated herein in its entirety.

An OpenID can receive payments through a messaging application if it is associated with a payee account for receiving payments. For example, an OpenID may register a payee account 105 with the mobile payment transaction server 101 to be able to receive payments from the users of the messaging application. Further, the OpenID may register its domain name associated with the payee account 105 with the mobile payment transaction server 101. This domain name can be used for purposes of certification to be used with the mobile payment transaction server 101. The messaging application module 115 may include a certification mark generated by its source code on the user interface showing information from the OpenID. It can be readily understood by one of ordinary sill in the art that by including the certification mark, a user may be protected from being misled into a fake website/application interface mimicking the authentic interface associated with the OpenID and losing personal information.

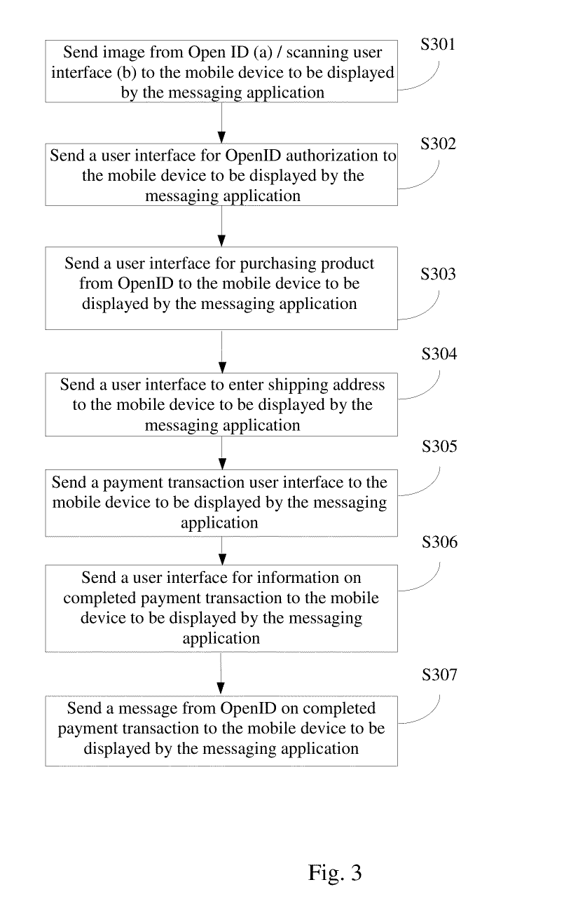

FIG. 3 is a flow chart illustrating exemplary steps of a process for making a payment, via a messaging application, to a merchant associated with an OpenID. In this example, the merchant may initiate the payment transaction by posting either a message in the messaging application or a 2D image outside of the messaging application, for example, in an advertisement or on a printed poster, etc. In the first embodiment, the payer may be associated with the merchant by its OpenID in the messaging application in order to receive the message. For example, the user may add the OpenID to his/her contact list, so that the OpenID can send messages about products and/or services to the user through the messaging application. The messaging application may allow an account holder to indicate different levels of interest to an OpenID. The levels can include, for example, “being interested in” the OpenID, “paying attention to” the OpenID, “liking” the OpenID, and “being a fan of” the OpenID, etc. Further, the messaging application may include controlling methods for the account holder to choose, remove or change his interest level regarding the OpenID, with only certain levels of interest allowing the OpenID to publish product information to the subscribing accounts.

Step 301a: A server, such as the mobile payment transaction server 101, can send a user interface including a message from an OpenID to the mobile device to be displayed by the messaging application. This user interface may be generated by the merchant server 103 connected to the mobile payment transaction server 101, and processed and displayed by the messaging application module 115 on the mobile device 102 (FIG. 1). As discussed elsewhere in the disclosure, a user of the messing application may receive the message from the OpenID if he/she is associated with the OpenID in the messaging application. The user interface may include a title with information of a product, such as a name of the product. The message may include an image, which may include information on the product, the merchant, etc. In addition, the image may include a certification mark showing that the image is certified by the messaging application, and the image is from a registered domain name associated with the OpenID that the messaging application has on record. Activating the image by touching or other input methods may lead to a user interface for authorization of the OpenID by the messaging application, or to a user interface for purchasing a product. The image may be hosted on the merchant server 103, and may contain information of a product, such as product ID, location, number in stock, etc.

Step 301b: A server, such as the mobile payment transaction server 101, can send a user interface for scanning a 2D image to the mobile device. The user interface for scanning a 2D image may be from another application, for example, an application for taking a picture or a video, on the mobile device, and may be activated within the messaging application. The user interface may include brackets showing the area within which the 2D image should be placed for scanning, and may further include a text telling the user to place the 2D image within the brackets. The user interface may include a title about “scanning” an image. Further, the user interface may include an interface item to cancel the current user interface and go back to a previous user interface, for example, the user interface in the messaging application from which the current user interface was launched. The 2D image may include encoded information associated with the product, such as product ID, location, number in stock, the merchant, etc. Scanning the 2D image by placing the 2D image within the brackets, touching the screen, or other input methods may lead to a user interface for authorization by the messaging application, or to a user interface for purchasing a product. The 2D image may be on a poster, a website, a mobile device, or in an advertisement, etc.

Step 302: A server, such as the mobile payment transaction server 101, can send an authorization user interface for following an OpenID to the mobile device to be displayed by the messaging application. When the messaging application module 115 receives a user acceptance to a message, or a scanned 2D image, from an OpenID that is not associated with the buyer, it may generate and send the authorization user interface to the mobile device 102 to be displayed by the messaging application 121, so that the buyer may associate with the OpenID. If the 2D image is scanned by another application, for example a picture taking application, the 2D image may be processed by the application. If the processed information indicates the 2D image is associated with an OpenID of the messaging application, the scanned 2D image may be forwarded to the messaging application module 115.

The user interface for authorization may include a title regarding the authorization status of the OpenID for selling products and/or services and/or for receiving payments using the messaging application. For example, the user interface for authorization may include a logo of the OpenID, with an optional check mark on the logo, name of the OpenID, a brief description, etc. The user interface for authorization may include an interface item for authorizing the buyer to log into the OpenID using the account number with the messaging application, and/or an interface item for allowing the buyer to pay attention to or follow the OpenID. Further, the user interface for authorization may include an interface item for accepting and/or denying the OpenID. The user interface for authorization may be skipped, for example, if the buyer has previously been associated with the OpenID, for example, if the buyer has been paying attention to or following the OpenID.

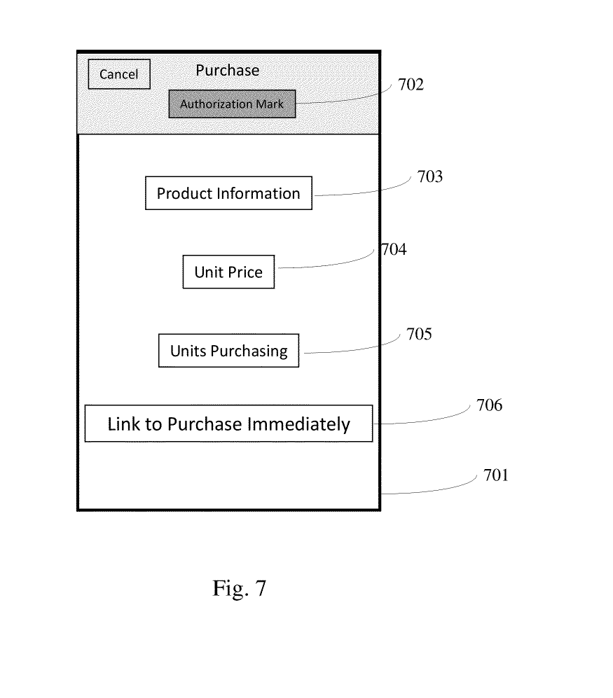

Step 303: A server, such as the mobile payment transaction server 101, can send a purchasing user interface to the mobile device to be displayed by the messaging application. The purchasing user interface may be initiated by the acceptance by the user in the authorization user interface in Step 302. Additionally or alternatively, the purchasing user interface may be initiated by activating an image from an OpenID within the messaging application, or by scanning a 2D image from an OpenID outside the messaging application, wherein the buyer is already paying attention or following the OpenID. After receiving the scanned 2D image from the mobile device 102 by the messaging application module 115, the 2D image may be decoded to reveal the product and/or merchant information by the image encoding/decoding module 114 of the mobile payment transaction server 101 (FIG. 1). The product ID may be forwarded to the merchant server 103, which then generates a user interface 701 (FIG. 7) showing the product information to be processed and displayed by the messaging application module 115 on the mobile device 102. As discussed elsewhere in the disclosure, the product information may only be hosted on the merchant server 103 in order to protect the privacy of the buyer.

As illustrated in FIG. 7, the purchasing user interface may include a title. The purchasing user interface may further include a certification mark 702, which may serve to distinguish fake websites/applications that are not generated through the messaging application. Any suitable items, such as a check mark, a background color, a short text in the browser title, etc. may be used as the certification mark. The certification may be generated by software that is part of the messaging application module 115, and therefore cannot be mimicked by a third party. The messaging application module 115 may use the domain name associated with the OpenID for the purpose of certification. Only if the domain name of the website matches the domain name registered by the OpenID with the messaging application, a certification mark 702 can be shown as a part of the title on the purchasing user interface. The purchasing user interface may include information of the product 703, such as brief description, image, sales record, color, size, unit price 704, etc.; interface items to change the quantity in the transaction 705; and the total price of the transaction 706. The user interface may include an interface item 706 to make the purchase. Further, the purchasing user interface may include an interface item for returning to a previous user interface, for example, the user interfaces in Steps 301(a) or 301(b), or the authorization user interface in Step 302.

Step 304: A server, such as the mobile payment transaction server 101, can send a user interface for entering a shipping address to the mobile device to be displayed by the messaging application. The interface may be initiated by the input to purchase in the purchasing user interface in Step 303. After receiving the purchase information from the purchasing user interface (FIG. 7), the messaging application module 115 may forward the purchase information to the transaction information module 111, which can generate a shipping address user interface to be processed and displayed by the messaging application module 115. The user interface for entering a shipping address may also include input fields that may be operated from the client device using, for example, a JavaScript (JS) API. Advantages associated with this configuration include better user experience through interactive features, such as automatic suggestions or fill-ins for Zip code, fast response, etc.

This user interface for entering a shipping address may be skipped if one has been saved previously, for example, if a shipping address is on record for this OpenID, this account with the messaging application, or this mobile device. The user interface may include input fields for a shipping address including, but not limited to, buyer name, country, address, zip code, phone number, etc. The input fields of the user interface may be automatically filled according to the shipping address on record. Further, the user interface may include an interface item to save the shipping address. The shipping address may be further linked to the payer account number associated with the messaging application, the mobile device, and/or the OpenID. The shipping address may be saved and called up by the client device to improve customer experience.

Step 305: A server, such as the mobile payment transaction server 101, can send a user interface for payment transaction to the mobile device to be displayed by the messaging application. After receiving the shipping user interface in Step 304 or the purchase information from the purchasing user interface in Step 303 when a shipping address is already on record, the transaction information module 111 may generate the payment transaction user interface to be processed and displayed by the messaging application module 115 on the mobile device 102. The user interface for payment transaction may include different interface items according to the status of a payer account associated with the mobile device in the messaging application. If a payer account 104 is already associated with the mobile device 102, the transaction information module 111 may get the payer account number and the phone number associated with the mobile device 102 and include the payer account number in the payment transaction user interface (see, e.g., FIG. 8).

The payment transaction user interface 801 may be modified for a merchant that requires a specified payment account, for example, iTunes by Apple. In such situations, the payment transaction user interface 801 may be redirected to the native payment interface from the merchant, and the payment may be completed by entering the required information in the merchant's payment interface.

In situations where a payer account has not been associated with the mobile device, the user interface may include a link to set up a payer account to be associated with the mobile device in the messaging application, as described in Steps 201-206 (FIG. 2). In situations where a payer account has been associated with the mobile device, the user interface may include information of the payer account associated with the mobile device 803, and an input field to enter the password 804 that is on record for the associated payer account. As used herein, a payment transaction user interface 801 may include information about a payment transaction 802, for example, information on a product to be purchased by the buyer, such as price, brief description, color selection, size; quantity of the product to be purchased; and the total value of the transaction. Further, the payment transaction user interface 801 may include an interface item to cancel the operation and return to a previous user interface, such as the user interface for entering shipping address or purchasing user interface, and an interface item 805 to make the payment.

Step 306: A server, such as the mobile payment transaction server 101, can send a user interface for information on a completed payment transaction to the mobile device to be displayed by the messaging application. This user interface is the same to the one in Step 206 (FIG. 2). After receiving the password entered by the buyer, the payment processing module 113 may verify the password with the one on record for the payer account 104 associated with the mobile device 102, and initiate a transfer of payment from the payer account 104 to the payee account 105 (FIG. 1). When the payment transaction has been completed, the transaction information module 111 may be informed of the status of the payment transaction by the payment processing module 113, and in turn inform the merchant server 103. The payment processing module 113 may generate the user interface on the completed payment transaction to the processed and displayed by the messaging application module 115 on the mobile device 102 (FIG. 1).

The user interface may include information on the completed payment transaction including, but not limited to, name of the payee, name of the product, transaction number, transaction completion time, name of the financial institution of the payer account, status of the transaction, a customer service number, value of the transaction, etc. Further, the user interface may include an interface item to complete the account associating process and return to the user interface before the transaction was initiated.

Optionally, a user interface for entering a confirmation code may be displayed. This user interface may be used to confirm that the mobile device making the payment is the same as the one associated with the payer account if, for example, the total transaction amount exceeds a predetermined threshold. Upon receiving the password entered by the buyer from the payment transaction user interface 801, the payment processing module 113 may obtain the payer account information, including the phone number associated with the payer account 104, and send a confirmation code to the phone number through text messaging. The user interface may include an input field to enter the confirmation code. The user interface may also include a touch-based input device, such as a virtual keyboard, to enter the confirmation code. The user interface may include a short text reminding the payer the phone number the confirmation code was sent, with one or more of the digits blanked out. The user interface may include an interface item for the payer to receive the confirmation code. Activating the interface item for receiving the confirmation code may lead the mobile payment transaction server 101 to send a text message to the phone number associated with the payer account 104. Further, the user interface may include an interface item to go back to the previous user interface, for example, the payment transaction user interface, and/or an interface item to make the payment and go to the next user interface, for example, a user interface for information on completed payment transaction.

Step 307: A server, such as the mobile payment transaction server 101, can send a purchase completion message to the mobile device to be displayed in the messaging application. After the messaging application module 115 receives a confirmation from the payment transaction module 113 that a payment transaction has been completed, the messaging application module 115 may send a notification to the merchant server 103, which in turn can send a message to the buyer about the completed purchase to be displayed by the messaging application module 115 on the mobile device 102.

### Payment by Scanning a 2D Image on a Website

Further provided herein is a method for making a payment transaction by scanning a 2D image on a website. The 2D image may encode information for a transaction, for example, in a text string encoding a transaction ID. The 2D image may be encoded by the image encoding/decoding module 114 of the mobile payment transaction server 101 and forwarded to the messaging application module 115 (FIG. 1). By scanning the 2D image with a mobile device 102 using the messaging application, the transaction ID and the buyer information may be transferred to the merchant to become a completed order. Advantages associated with this payment method include increased security when making a purchase on a public computer, because no private account information needs to be entered into the computer. It can also increase the efficiency of making payment on a merchant's website, because it can eliminate the need to log into a third party payment account. To use this mobile payment method, the merchant may need to register a payee account 105 with the mobile payment transaction server 101, and connect its server 103 to the mobile payment transaction server 101.

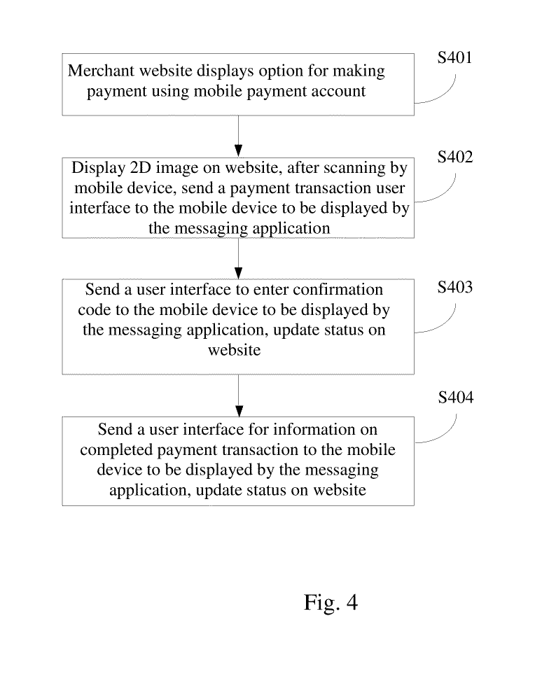

FIG. 4 is a flow chart illustrating exemplary steps of a process for making a payment to a merchant by scanning a 2D image displayed on a website. Step 401: displaying, on the screen of a mobile device, a user interface for selecting payment methods on the merchant's website. The merchant's website may include a page for the buyer to select from multiple payment options, one of which is by payment through a messaging application on a mobile device.

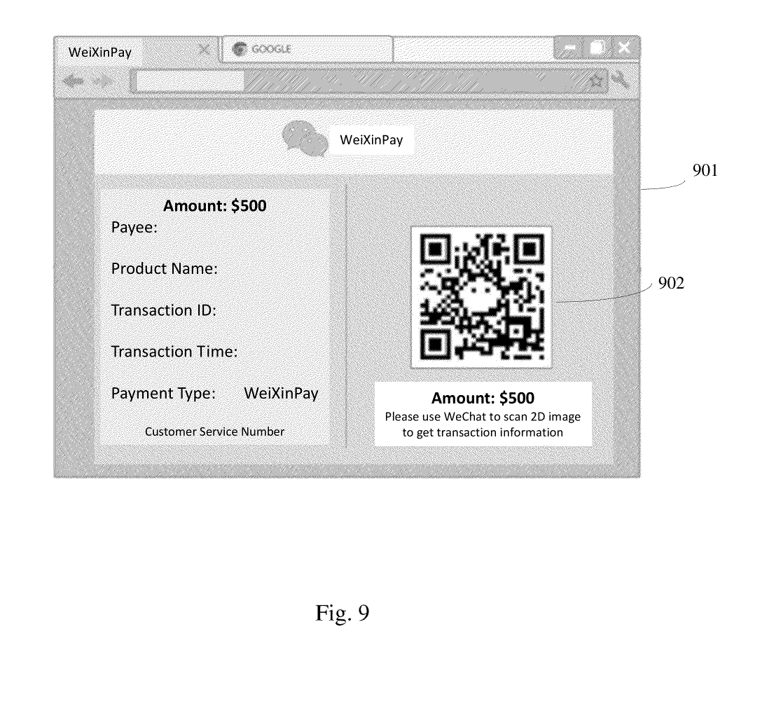

Step 402: A server, such as the mobile payment transaction server 101, can send a user interface for payment transaction to a computer to be displayed on a website, which may include a 2D image. Upon the selection of this payment option, a payment transaction page 901 may be displayed on a website with information for the payment transaction and a 2D image 902 (FIG. 9). The transaction information module 111 may receive the payment transaction information from the merchant server 103, and forward the information to the transaction identity module 112, which can generate a unique transaction identity. The image encoding/decoding module 114 may encode the unique transaction identity into a 2D image 902, to be displayed by the messaging application module 115 on a website 901. The website may be hosted by the mobile payment transaction server 101.

The 2D image 902 may encode information specific for the payment transaction, such as transaction ID, product ID, time of the transaction, etc. The merchant server 103 or the messaging application module 115 may set a time frame wherein the 2D image is active, after which the 2D image may be inactivated. For example, the time frame may vary from about 5 minutes to about 24 hours or longer.

The 2D image may be scanned using a mobile device 102 running the messaging application, which can lead to a payment transaction user interface. After receiving the scanned 2D image from the mobile device 102 by the messaging application module 115, the 2D image may be decoded by the image encoding/decoding module 114 to get the transaction ID. The transaction ID may then be matched with the transaction ID saved on the transaction information module 111, which in turn can generate a payment transaction user interface to be processed and displayed by the messaging application module 115 on the mobile device 102. The messaging application module 115 may also receive identity information, such as the phone number associated with the mobile device 102, associated with the mobile device 102 from which the scanned 2D image was sent.

In embodiments where a payer account has already been associated with the mobile device 102, the payment transaction user interface 801 may include information on the associated payer account 803 and an input field for the payment password 804 (FIG. 8). In embodiments where a payer account has not been associated with the mobile device, the payment transaction interface 601 may include a link 603 to complete the association of a payer account with the mobile device, similar to that in Step 201 (FIGS. 2 & 6).

Further, the messaging application module 115 may be notified that the 2D image 902 has been successfully scanned, and update the status of the 2D image 902 on the website 901. The messaging application module 115 may inactivate the 2D image 902, and/or the transaction ID encoded by the 2D image 902, so that scanning it again would not lead to a duplicated payment transaction. If the payment processing module 113 determines that the total value of the transaction is greater than a threshold, the messaging application module 115 may inform the merchant that the 2D image 902 cannot be scanned. In turn, the messaging application module 115 may update the payment transaction page 901 with a message that the transaction exceeds the threshold for payment with the messaging application.

Optionally, a user interface for entering a shipping address, such as the one described in Step 304, may be displayed if none is included in the transaction information received by the transaction information module 111. This user interface for entering a shipping address may be skipped if one has been saved, for example, a shipping address is on record for this merchant, this payer account, or this mobile device. The user interface my include input fields for a shipping address including, but not limited to, buyer name, country, address, zip code, phone number, etc. The input fields of the user interface may be automatically filled according to the shipping address on record. Further, the user interface may include an interface item to save the shipping address. The shipping address may be further linked to the payer account number associated with the messaging application, the mobile device, and/or the merchant. The shipping address may be saved and called up by the client device to improve customer experience. The user interface for entering a shipping address may include input fields that may be operated from the client device using, for example, a JavaScript (JS) API. Advantages associated with this configuration can include better user experience through interactive features, such as automatic suggestions for Zip code, fast response, etc.

Step 403: displaying a user interface on the mobile device for entering a confirmation code. This user interface may be used to confirm that the mobile device 102 used to scan the 2D image 902 is the same one associated with the payer account 104. Upon receiving the password entered by the buyer from the payment transaction user interface 801, the payment processing module 113 may obtain the payer account information, including the phone number associated with the payer account 104, and send a confirmation code to the phone number through text messaging. The user interface may include an input field to enter the confirmation code. The user interface may also include a touch-based input device, such as a virtual keyboard, to enter the confirmation code. The user interface may include a short text reminding the payer the phone number the confirmation code was sent, with one or more of the digits blanked out. The user interface may include an interface item for the payer to receive the confirmation code. Activating the interface item for receiving the confirmation code may lead the mobile payment transaction server 101 to send a text message to the phone number associated with the payer account 104. Further, the user interface may include an interface item to go back to the previous user interface, for example, to the payment transaction user interface, and/or an interface item to make the payment and go to the next user interface, for example, a user interface for information on completed payment transaction.

Step 404: A server, such as the mobile payment transaction server 101, can send a user interface for information on a completed payment transaction to the mobile device to be displayed by the messaging application. After the messaging application module 115 receives the confirmation code and verifies that the mobile device has the same mobile number as the one on record for the payer account, it can inform the payment transaction module 113 to complete the transaction. After receiving the password entered by the buyer, the payment processing module 113 may verify the password with the one on record for the payer account 104 associated with the mobile device 102, and initiate a transfer of payment from the payer account 104 to the payee account 105 (FIG. 1). When the payment transaction has been completed, the transaction information module 111 may be informed of the status of the payment transaction by the payment processing module 113, and in turn can inform the merchant server 103. The payment processing module 113 may generate the user interface on the completed payment transaction to the processed and displayed by the messaging application module 115 on the mobile device 102 (FIG. 1).

The messaging application module 115 may also display a transaction completion page on the website. Further, the merchant may be informed by the mobile payment transaction server 101 about the completed transaction, and may update its payment page with the information on the completed transaction.

Further contemplated is a method for scanning a 2D image on a package when the buyer receives the shipment to enable a collection on delivery (COD) method. The 2D image on the package may encode transaction information. Upon receiving a scanned 2D image from the mobile device 102 running the messaging application 121, the mobile payment transaction server 101 may complete the transaction by making payment to the payee account 105 from the payer account 104 associated with the mobile device 102.

Payment from Another Application on the Mobile Device

Further provided herein is a process to make a payment using a payer account associated with a mobile device wherein the transaction is initiated from another application on the mobile device. It is contemplated by the present disclosure that any mobile application by a merchant, as long as it has an established payee account 105 associated with the messaging payment transaction server 101, may be enabled to accept payment from buyer having a payer account 104 associated with the mobile device 102. For example, the mobile application may belong to a merchant having an OpenID, which enables feedback and interaction between the merchant and the buyer. The mobile application may be a retailer (Amazon, TaoBao, DangDang, Ebay, Newegg, Bestbuy, etc.), a game (e.g., Angry Birds, etc.), a multimedia distributor (e.g., Netflix, Hulu, Youtube, Apple Store, Google Play, Amazon Prime, etc.), or a service provider, etc.

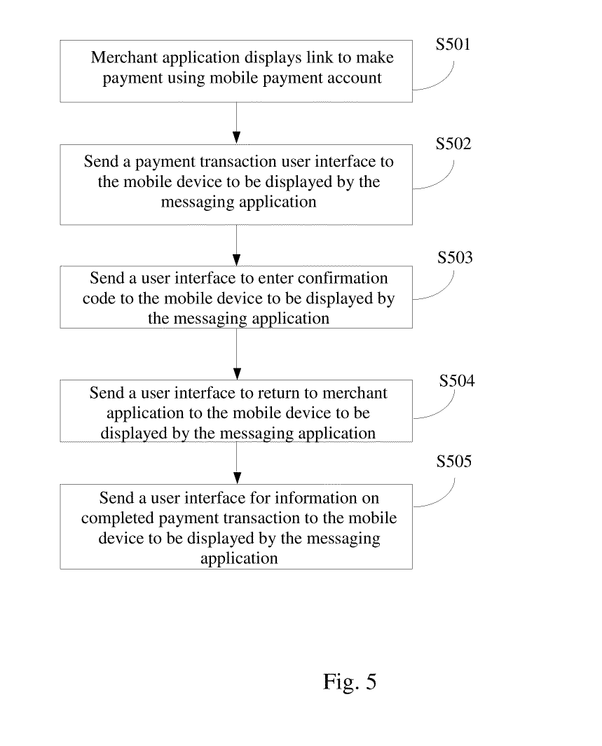

FIG. 5 is a flow chart illustrating exemplary steps of a process to make a payment to a merchant from another application running on a mobile device. Step 501: displaying, on the mobile device, a link to make a mobile payment in another application. The initiating application may belong to a merchant. The merchant may be associated with a payee account 105 that can be connected to the mobile transaction payment server 101. The merchant may also be associated with a third party payment account, wherein the mobile payment transaction server 101 may make payment to. Further, the merchant may register its domain name associated with the third party payment account with the mobile payment transaction server 101. This domain name can be used for purposes of certification by the mobile payment transaction server 101.

Step 502: A server, such as the mobile payment transaction server 101, can send a user interface for payment transaction to the mobile device to be displayed by the messaging application. On the user interface of the initiating application, a link to use the mobile payment method may be displayed. After the link is activated by the user, the information on a payment transaction may be received by the transaction information module 111 from a merchant server 103, which is associated with the initiating application on the mobile device 102. The phone number associated with the mobile device 102 may also be obtained by the payment processing module 113, and matched with a phone number on record for a payer account 104. A user interface for payment transaction may be generated by the transaction information module 111, and processed and displayed by the messaging application module 115 on the mobile device 102. In embodiments where a payer account has already been associated with the mobile device, the payment transaction user interface may include information on the associated payer account and an input field for the password, similar to the user interface in Step 305 (FIGS. 3 & 8). In embodiments where a payer account has not been associated with the mobile device, the payment transaction interface may include a link to complete the associating of a payer account with the mobile device, similar to that in Step 201 (FIG. 2).

Optionally, a user interface for entering a shipping address, such as the one described in Step 304, may be displayed if none is included in the transaction information received by the transaction information module 111. This user interface for entering a shipping address may be skipped if one has been saved, for example, a shipping address is on record for this merchant, this payer account, or this mobile device. The user interface may include input fields for a shipping address including, but not limited to, buyer name, country, address, zip code, phone number, etc. The input fields of the user interface may be automatically filled according to the shipping address on record. Further, the user interface may include an interface item to save the shipping address. The shipping address may be further linked to the payer account number associated with the messaging application, the mobile device, and/or the merchant. The shipping address may be saved and called up by the client device to improve customer experience. The user interface for entering a shipping address may include input fields that may be operated from the client device using, for example, a JavaScript (JS) API. Advantages associated with this configuration can include better user experience through interactive features, such as automatic suggestions for Zip code, fast response, etc.

Step 503: A server, such as the mobile payment transaction server 101, can send a user interface for entering a confirmation code to the mobile device to be displayed by the messaging application. This user interface may be used to confirm that the mobile device 102 is the same one associated with the payer account 104. Upon receiving the payment password from the payment transaction user interface 801, the payment processing module 113 may obtain the payer account information, including the phone number associated with the payer account, and send a confirmation code to the phone number through text messaging. The user interface may include an input field to enter the confirmation code, and a touch-based input device, such as a virtual keyboard, to enter the confirmation code. The user interface may include a short text reminding the payer the phone number the confirmation code was sent, with one or more of the digits blanked out. The user interface may comprise an interface item for the payer to receive the confirmation code. Activating the interface item for receiving the confirmation code may lead the mobile payment transaction server 101 to send a text message to the phone number associated with the payer account 104. The user interface may include an interface item to go back to the previous user interface, for example, to the payment transaction user interface, and/or an interface item to make the payment and go to the next user interface, for example, a user interface for information on completed payment transaction.

Step 504: A server, such as the mobile payment transaction server 101, can send a user interface for selecting to remain in the messaging application or return to the originating application to the mobile device to be displayed by the messaging application. After the messaging application module 115 receives the confirmation code and verifies that the mobile device has the same phone number as the one on record for the payer account, it may inform the payment transaction module 113 to complete the transaction. The messaging application module 115 may display a transaction completion page with options for the buyer to remain in the messaging application or return to the merchant's application. After receiving the password entered by the buyer, the payment processing module 113 may verify the password with the one on record for the payer account 104 associated with the mobile device 102, and initiate a transfer of payment from the payer account 104 to the payee account 105 (FIG. 1). When the payment transaction has been completed, the transaction information module 111 may be informed of the status of the payment transaction by the payment processing module 113, and in turn informs the merchant server 103. The payment processing module 113 may generate the user interface on the completed payment transaction to the processed and displayed by the messaging application module 115 on the mobile device 102 (FIG. 1).

Step 505: A server, such as the mobile payment transaction server 101, can send a user interface for information on completed payment transaction to the mobile device to be displayed by the messaging application. Upon the selection by the user to remain in the messaging application, the messaging application module 115 may display information on the completed transaction. The user interface may include information on the completed payment transaction including, but not limited to, name of the payee, name of the product, transaction number, transaction completion time, name of the financial institution of the payer account, status of the transaction, a customer service number, value of the transaction, etc. Further, the user interface may include an interface item to complete the account associating process and return to the user interface before the transaction was initiated.

Persons of ordinary skill in the art can readily appreciate that all or part of the steps of the methods described in the embodiments above, such as the exemplary steps shown in the flow charts of FIGS. 2-5, can be performed by modules of the respective systems, including the mobile payment transaction system, merchant server, mobile device illustrated in FIG. 1. In some embodiments, each step in the flow chart can be performed by a dedicated module. In other embodiments, one or more steps can be performed by the same module. It should be understood that one or more of these modules can be implemented in hardware, firmware, and/or software. In one embodiment, all of the modules can be implemented in software. The modules can be programs stored on a non-transitory computer-readable medium such as a read-only memory (“ROM”), a random access memory (“RAM”), a magnetic disk or a compact disc. When executed by a processor, the modules can perform one or more steps discussed in the embodiments above.

Although the disclosed embodiments have been fully described with reference to the accompanying drawings, it is to be noted that various changes and modifications will become apparent to those skilled in the art. Such changes and modifications are to be understood as being included within the scope of the disclosed embodiments as defined by the appended claims.

What is claimed is:

1. A mobile payment transaction server that facilitates payment via a messaging application associated with a mobile device, the server comprising:
a transaction information module that retrieves and processes information associated with a payment transaction,
a transaction identity module that generates and manages a unique transaction identity associated with the payment transaction,
a messaging application module that communicates the information associated with the payment transaction and retrieves information associated with a payer account via a user interface of the messaging application, and
a payment processing module that processes the payment transaction using the unique transaction identity and the information associated with the payer account.

2. The server of claim 1, wherein the server is configured to communicate with the payer account.

3. The server of claim 1, wherein the server is configured to communicate with a payee account.

4. The server of claim 1, wherein the payer account is associated with a user of the messaging application.

5. The server of claim 3, wherein the payee account is associated with an OpenID of the messaging application.

6. The server of claim 1, wherein the messaging application comprises a microblogging application or an instant messaging application.

7. The server of claim 1, comprising an image encoding/decoding module that encodes/decodes an image comprising information associated with the payment transaction.

8. A mobile device that makes a payment transaction through a messaging application, the mobile device being associated with a payer account, the messaging application comprising a user interface that displays information associated with the payment transaction and a user interface that enables access to information associated with the payer account, the payment transaction being processed using the information associated with the payer account.

9. The mobile device of claim 8, wherein the mobile device is associated with a phone number and wherein the payer account is associated with the phone number of the mobile device.

10. The mobile device of claim 8, wherein the payer account is associated with a user of the messaging application.

11. The mobile device of claim 8, wherein the payer account is associated with a payment company.

12. The mobile device of claim 8, wherein a payee account is associated with an OpenID of the messaging application.

13. The mobile device of claim 8, wherein the messaging application comprises a microblogging application or an instant messaging application.

14. A system for making a payment transaction from a messaging application on a mobile device, the system comprising:
a transaction information module that receives and processes information associated with a payment transaction,
a transaction identity module that generates and manages a unique transaction identity associated with the payment transaction,
a messaging application module that communicates the information associated with the payment transaction and retrieves information associated with a payer account via a user interface of the messaging application,
a payment processing module that processes the payment transaction using the unique transaction identity and the information associated with the payer account, and
a mobile communications module that transmits data to and/or retrieves data from the mobile device.

15. The system of claim 14, wherein the mobile communications module and the mobile device communicate via a wireless network.

16. The system of claim 14, comprising a merchant communications module that transmits data to and/or retrieves data from a merchant server.

17. The system of claim 16, wherein the merchant server comprises product information associated with the payment transaction.

18. The system of claim 16, wherein the merchant communications module and the merchant server communicates via an internet connection.

19. A method of associating a payer account and a mobile device, the method comprising: a server
sending a user interface for entering a payer account number to the mobile device to be displayed by a messaging application,
obtaining from the mobile device the payer account number,
sending a user interface to the mobile device for entering a phone number assigned to the mobile device to be displayed by the messaging application,
obtaining from the mobile device the phone number,
sending a user interface for entering a payment password to be displayed by the messaging application,
obtaining from the mobile device the payment password, and
associating the payer account number with the phone number.

20. The method of claim 19, comprising verifying the payer account number.

21. The method of claim 20, comprising verifying the phone number.

22. The method of claim 21, comprising sending an authorization text message to the phone number, and verifying the phone number by matching a text input from the mobile device with the authorization text message.

23. A method of performing a payment transaction from a messaging application on a mobile device, the method comprising: a server
sending information associated with a product from a payee to the mobile device to be displayed by the messaging application, the payee having an account associated with the messaging application,
sending a user interface to the mobile device to be displayed by the messaging application, comprising an offer from the payee, information associated with a payer account associated with the mobile device, and an input field for entering a payment password, and
obtaining the entered payment password from the mobile device, completing the payment transaction on a server using the payer account when the payment password entered matches the payment password on record for the payer account associated to the mobile device,
wherein the offer comprises information associated with the payment transaction.

24. The method of claim 23, wherein the payee has an OpenID associated with the messaging application.

25. The method of claim 23, wherein the payer has an account associated with the messaging application.

26. The method of claim 23, wherein the messaging application comprises a microblogging application or an instant messaging application.

27. The method of claim 25, wherein the payer is associated with the payee in the messaging application.

28. The method of claim 25, wherein a message from the payee is sent to the payer in the messaging application after the completion of the payment transaction.

29. The method of claim 28, wherein the message comprises a ticket, a password, or a registration confirmation.

30. The method of claim 23, comprising sending information of the completed payment transaction to the mobile device to be displayed by the messaging application.

31. A method of performing a payment transaction from a messaging application on a mobile device, the method comprising: a server
receiving from the mobile device a scanned 2D image from a payee, the payee having an account with the messaging application,
sending a user interface to the mobile device to be displayed by the messaging application, comprising an offer from the payee, information on a payer account associated with the mobile device, and an input field for entering a payment password, and
obtaining the entered payment password from the mobile device, completing the payment transaction on a server using the payer account when the payment password entered matches the payment password on record for the payer account associated to the mobile device,
wherein the offer comprises information associated with the payment transaction.

32. The method of claim 31, wherein the 2D image comprises an image on a poster, an advertisement, a website, or a mobile device.

33. The method of claim 31, wherein the payee has an OpenID associated with the messaging application.

34. The method of claim 31, comprising sending an invitation to the payer to be associated with the payee in the messaging application.

35. The method of claim 31, comprising sending information of the completed payment transaction to the mobile device to be displayed by the messaging application.

36. A method of performing a payment transaction from a messaging application on a mobile device, the method comprising: a server
displaying a 2D image on a website, wherein the 2D image comprises information associated with the payment transaction,
receiving from the mobile device the scanned 2D image,
sending a user interface to the mobile device to be displayed by the messaging application, comprising an offer from a payee, information on a payer account associated with the mobile device, and an input field for entering a payment password, and
obtaining the entered payment password from the mobile device, completing the payment transaction on a server using the payer account when the payment password entered matches the payment password on record for the payer account associated to the mobile device,
wherein the offer comprises the information associated with the payment transaction.

37. The method of claim 36, wherein the website is hosted by a messaging application module of the server.

38. The method of claim 36, wherein the 2D image has an expiration time.

39. The method of claim 36, wherein the 2D image is inactivated after the server receives from the mobile device the scanned 2D image.

40. The method of claim 36, comprising sending information of the completed payment transaction to the mobile device to be displayed by the messaging application.

41. A method of performing a payment transaction from a messaging application on a mobile device, the method comprising: a server
receiving information associated with the payment transaction from another application from a payee,
sending a user interface to the mobile device to be displayed by the messaging application, comprising an offer from the payee, information on a payer account associated with the mobile device, and an input field for entering a payment password, and
obtaining the entered payment password from the mobile device, completing the payment transaction on a server using the payer account if the payment password entered matches the payment password on record for the payer account associated to the mobile device,
wherein the offer comprises the information associated with the payment transaction.

42. The method of claim 41, comprising sending a user interface for returning to the application from the payee to the mobile device to be displayed by the messaging application.

43. The method of claim 41, comprising sending information of the completed payment transaction to the mobile device to be displayed by the messaging application.

44. A non-transitory computer-readable medium storing one or more programs, when executed by a processor, performing the steps of
sending a user interface for entering a payer account number to the mobile device to be displayed by a messaging application,
obtaining from the mobile device the payer account number,
sending a user interface to the mobile device for entering a phone number assigned to the mobile device to be displayed by the messaging application,
obtaining from the mobile device the phone number,
sending a user interface for entering a payment password to be displayed by the messaging application,
obtaining from the mobile device the payment password, and
associating the payer account number with the phone number.
